(19) United States
(12) Patent Application Publication
(10) Pub. No.: US 2012/0143482 A1
(43) Pub. Date: Jun. 7, 2012

(54) ELECTRONICALLY FILE AND FLY UNMANNED AERIAL VEHICLE

(75) Inventors: Emray Goossen, Albuquerque, NM (US); Derick Lucas Gerlock, Albuquerque, NM (US)

(73) Assignee: Honeywell International Inc., Morristown, NJ (US)

(21) Appl. No.: 12/959,078

(22) Filed: Dec. 2, 2010

(51) Int. Cl. G08G 5/00

(52) U.S. Cl. 701/120

(57) ABSTRACT

Flight plans for an unmanned aerial vehicle (UAV) are automatically generated and filed with an air traffic control (ATC) system to quickly and easily secure approval for flying the UAV in a controlled airspace. In one example, one or more flight locations for a UAV are defined using a computing device. Using the computing device, an electronic flight plan is automatically generated based on the defined flight locations for the UAV. The flight plan can be transmitted to an ATC system. ATC approval, with or without modifications, or denial of the flight plan may also be received electronically and indicated on the operator device.

### TECHNICAL FIELD

The disclosure relates to techniques for operating unmanned aerial vehicles in controlled airspaces.

### BACKGROUND

An unmanned aerial vehicle (UAV) is an aircraft that flies without a human crew on board the aircraft. A UAV can be used for various purposes, such as the collection of ambient gaseous particles, observation, thermal imaging, and the like. A micro air vehicle (MAV) is one type of UAV, which, due to its relatively small size, can be useful for operating in complex topologies, such as mountainous terrain, urban areas, and confined spaces. The structural and control components of a MAV are constructed to be relatively lightweight and compact.

### SUMMARY

In general, this disclosure is directed to devices, systems, and techniques for operating a UAV in a controlled airspace. In one example, a method of automatically filing a flight plan includes defining, using a computing device, one or more flight locations for a UAV, automatically generating, using the computing device, an electronic flight plan based on the one or more flight locations for the UAV, and transmitting the flight plan to an air traffic control (ATC) system.

In another example, an operator control unit (OCU) for UAV includes a processor and a display. The processor is configured to define one or more flight locations for the UAV, automatically generate an electronic flight plan based on the one or more flight locations for the UAV, and transmit the flight plan to an ATC system. The display is configured to represent the one or more flight locations for the UAV.

In another example, a computer-readable storage medium includes instructions for causing a programmable processor to define one or more flight locations for a UAV, automatically generate an electronic flight plan based on the one or more flight locations for the UAV, and transmit the flight plan to an ATC system.

In another aspect, the disclosure is directed to an article of manufacture comprising a computer-readable storage medium. The computer-readable storage medium comprises computer-readable instructions for execution by a processor. The instructions cause a programmable processor to perform any part of the techniques described herein. The instructions may be, for example, software instructions, such as those used to define a software or computer program. The computer-readable medium may be a computer-readable storage medium such as a storage device (e.g., a disk drive, or an optical drive), memory (e.g., a Flash memory, read only memory (ROM), or random access memory (RAM)) or any other type of volatile or non-volatile memory that stores instructions (e.g., in the form of a computer program or other executable) to cause a programmable processor to perform the techniques described herein. The computer-readable storage medium can be nontransitory.

The details of one or more examples are set forth in the accompanying drawings and the description below. Other features, objects, and advantages of the disclosed examples will be apparent from the description and drawings, and from the claims.

### BRIEF DESCRIPTION OF DRAWINGS

FIG. 1 is schematic diagram of a vehicle flight system including a UAV and a ground station.

FIG. 2 is an example operator control unit (OCU) for controlling the flight of the UAV of FIG. 1.

FIG. 3 is an example flight plan.

FIG. 4. is a block diagram illustrating example components of the example OCU of FIG. 2.

FIG. 5 is a flow chart illustrating an example method of automatically generating and filing a flight plan for a UAV in a controlled airspace.

### DETAILED DESCRIPTION

The rapidity with which emergency personnel respond to an event may be critical to the success of their mission. For example, military personnel or first responders, including, e.g., Hazardous Materials (HAZMAT) and Special Weapons and Tactics (SWAT) teams, fireman, and policeman, may be required to respond quickly to dynamic and unpredictable situations. In the execution of their duties, such emergency personnel may employ a UAV for surveillance, reconnaissance, and other functions. Because, e.g., first responders operate in populated and often highly populated urban areas, they may need to employ the UAV in one or more types of controlled airspaces. In some cases and in certain airspaces, Federal Aviation Administration (FAA) regulations may require the first responders to file a flight plan before they can fly the UAV to carry out their mission or accomplish their objectives. However, conventional mechanisms for filing flight plans with an Air Traffic Control (ATC) system may be too time consuming and complicated, which may be detrimental to the ability of the first responders to carry out their duties in an effective and responsive manner. In some cases, the first few minutes after the SWAT team or other responders respond to a situation may be critical to assessment of the situation. Accordingly, flying the UAV as soon as possible within the mission may be important in some cases.

The devices, systems, and techniques described in this disclosure are directed to automatically generating and filing an electronic flight plan for a UAV with an ATC system to quickly and easily secure approval for flying the UAV in a controlled airspace. The disclosed examples may facilitate workload reduction on operators, reduce error in planning and ATC coordination, speed the ATC approval process, and provide hazard reduction separation planning between operators and the ATC controller. In one example, one or more flight locations for a UAV are defined with a computing device. An electronic flight plan is automatically generated based on the defined flight locations for the UAV. The flight plan is transmitted to an ATC system. ATC approval, with or without modifications, or denial of the flight plan may also be received electronically and indicated on the operator device.

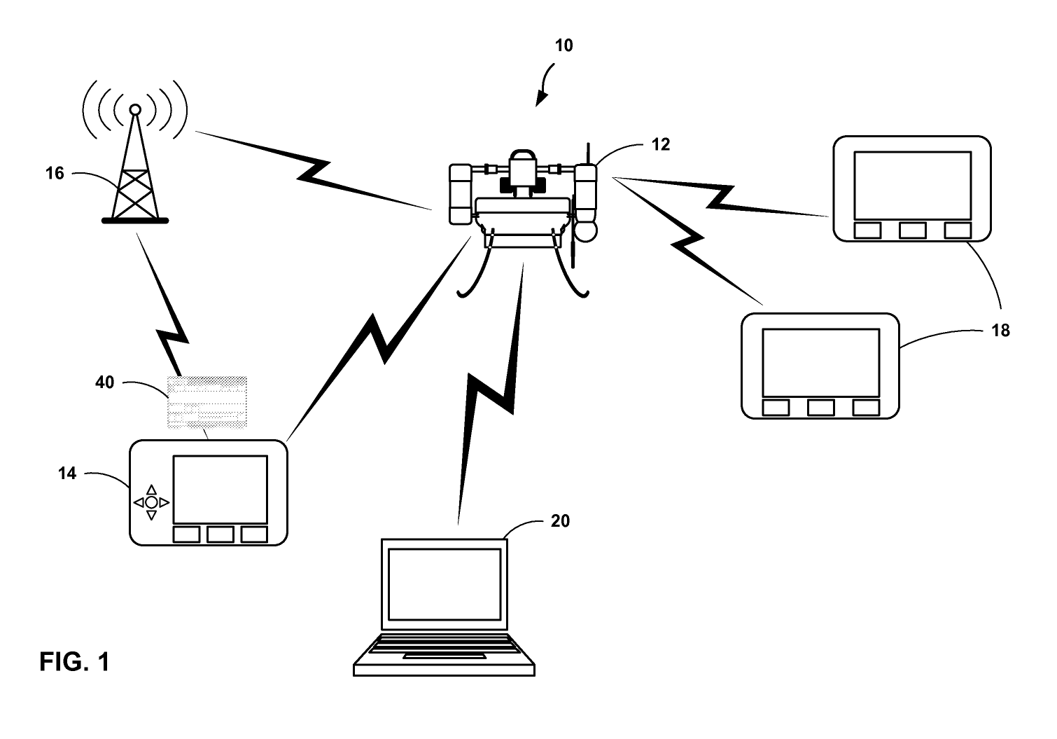

FIG. 1 is schematic diagram of system 10 including UAV 12, ground station 14, ATC tower 16, local terminals 18, and remote terminal 20. In FIG. 1, ground station 14, local terminals 18, and remote terminal 20 are each in wireless communication with UAV 12. Additionally, ATC tower 16 is in wireless communication with both UAV 12 and ground station 14.

The wireless communications to and from UAV 12 and ground station 14, ATC tower 16, local and remote terminals 18, 20, respectively, as well as the ground station and the ATC tower may include any of a number of wireless communication technologies, including, e.g., cellular, wireless network, or satellite technologies. For example, wireless communications in system 10 may be implemented according to one of the 802.11 specification sets, or another standard or proprietary wireless network communication protocol. In another example, system 10 may employ wireless communications over a terrestrial cellular network, including, e.g. a GSM (Global System for Mobile Communications), CDMA (Code Division Multiple Access), EDGE (Enhanced Data for Global Evolution) network. In other examples, any one or more of UAV 12, ground station 14, ATC 16, local terminals 18, and remote terminal 20 may communicate with each other via a wired connection.

System 10 may be employed for various missions, such as to assist emergency personnel with a particular mission that involves the use of UAV 12. In one example, a SWAT team may employ system 10 to fly UAV 12 in the course of executing one of their missions. For example, a SWAT team member trained in piloting UAV 12 may employ ground station 14 to communicate with and fly the UAV. Other SWAT team members may use local terminals 18 to receive communications, e.g. radio and video signals, from UAV 12 in flight. Additionally, a SWAT commander may employ remote terminal 20 to observe and manage the execution of the mission by, among other activities, receiving communications, e.g. radio, sensor feeds, and video signals from UAV 12 in flight. In other examples, system 10 may include more or fewer local and remote terminals 18, 20, respectively.

In the course of executing their missions, the SWAT team employing system 10 may be called on to pilot UAV 12 in populated, and, sometimes, highly populated urban areas. The FAA promulgates regulations for the operation of aerial vehicles in different kinds of airspaces. In unpopulated Class G areas, the FAA generally does not regulate air travel below 400 feet above the ground, which can be within the range a UAV employed by a SWAT or other emergency personnel may ordinarily fly. In some populated areas, the FAA may not regulate air travel below 400 feet for vehicles weighing less than some threshold, which again the UAV employed by a SWAT or other emergency personnel may be below.

However, in some urban populated areas, the FAA regulates air travel in an air space from the ground up for all types of vehicles. For example, in class C airspaces, which generally correspond to small airports in an urban area, the FAA requires all vehicles to file flight plans and be in contact with ATC before operating in the airspace. However, for emergency personnel, such as a SWAT team, filing and gaining approval for a flight plan every time it is called on to respond to an emergency situation with a UAV in a controlled airspace may require additional pilot training and may cause significant response time delays. For example, a SWAT team UAV pilot may not be trained in the technical requirements of FAA flight plan rules and regulations or be familiar with flight plan forms and terminology. As such, in order to manually generate and file flight plans, such first responder and other emergency personnel may require additional training. Naturally, manually filling out and physically delivering flight plans may be a time consuming process that acts to delay response times for SWAT and other emergency personnel.

In view of the foregoing, in one example of system 10, the SWAT UAV pilot of the SWAT team (or of another UAV pilot) may employ ground station 14 to automatically generate and file an electronic flight plan for UAV 12 with an ATC system via ATC tower 16, or via a wired communication network, to more quickly and easily secure approval for flying the UAV in a controlled airspace compared to examples in which the UAV pilot manually fills in a flight plan form and manually submits the form to ATC.

In one example, UAV 12 includes a ducted fan MAV, which includes an engine, avionics and payload pods, and landing gear. The engine of UAV 12 may be operatively connected to and configured to drive the ducted fan of the vehicle. For example, UAV 12 may include a reciprocating engine, such as a two cylinder internal combustion engine that is connected to the ducted fan of the UAV by an energy transfer apparatus, such as, but not limited to, a differential. In another example, UAV 12 may include other types of engines including, e.g., a gas turbine engine or electric motor.

The ducted fan of UAV 12 may include a duct and a rotor fan. In some examples, the ducted fan of UAV 12 includes both a rotor fan and stator fan. In operation, the engine drives the rotor fan of the ducted fan of UAV 12 to rotate, which draws a working medium gas including, e.g., air, into the duct inlet. The working medium gas is drawn through the rotor fan, directed by the stator fan and accelerated out of the duct outlet. The acceleration of the working medium gas through the duct generates thrust to propel UAV 12. UAV 12 may also include control vanes arranged at the duct outlet, which may be manipulated to direct the UAV along a particular trajectory, i.e., a flight path. The duct and other structural components of UAV 12 may be formed of any suitable material including, e.g., various composites, aluminum or other metals, a semi rigid foam, various elastomers or polymers, aeroelastic materials, or even wood.

As noted above, UAV 12 may include avionics and payload pods for carrying flight control and management equipment, communications devices, e.g. radio and video antennas, and other payloads. In one example, UAV 12 may be configured to carry an avionics package including, e.g., avionics for communicating to and from the UAV and ground station 14, ATC tower 16, and local and remote terminals 18, 20, respectively. Avionics onboard UAV 12 may also include navigation and flight control electronics and sensors. The payload pods of UAV 12 may also include communication equipment, including, e.g., radio and video receiver and transceiver communications equipment. In one example, UAV 12 includes communications antennae, which may be configured for radio and video communications to and from the UAV and one or more microphones and cameras for capturing audio and video while in flight. Other types of UAVs are contemplated and can be used with system 10 for example, fixed wing UAVs and rotary wing UAVs.

Local terminals 18 may be handheld or other dedicated computing devices, or a separate application within another multi-function device, which may or may not be handheld. Local terminals 18 may include one or more processors and digital memory for storing data and executing functions associated with the devices. A telemetry module may allow data transfer to and from local terminals 18 and UAV 12, local internet connections, ATC tower 16, as well as other devices, e.g. according to one of the wireless communication techniques described above.

In one example, local terminals 18 employed by, e.g., SWAT team members may include a portable handheld device including display devices and one or more user inputs that form a user interface, which allows the team members to receive information from UAV 12 and interact with the local terminal. In one example, local terminals 18 include a liquid crystal display (LCD), light emitting diode (LED), or other display configured to display a video feed from a video camera onboard UAV 12. In this manner, SWAT team members may employ local terminals 18 to observe the environment through which UAV 12 is flying, e.g., in order to gather reconnaissance information before entering a dangerous area or emergency situation, or to track a object, person or the like in a particular space.

Remote terminal 20 may be a computing device that includes a user interface that can be used for communications to and from UAV 12. Remote terminal 20 may include one or more processors and digital memory for storing data and executing functions associated with the device. A telemetry module may allow data transfer to and from remote terminal 20 and UAV 12, local internet connections, ATC tower 16, as well as other devices, e.g. according to one of the wireless communication techniques described above.

In one example, remote terminal 20 may be a laptop computer including a display screen that presents information from UAV 12, e.g., radio and video signals to the SWAT commander and a keyboard or other keypad, buttons, a peripheral pointing device, touch screen, voice recognition, or another input mechanism that allows the commander to navigate though the user interface of the remote terminal and provide input. In other examples, rather than a laptop, remote terminal 20 may be a wrist mounted computing device, video glasses, a smart cellular telephone, or a larger workstation or a separate application within another multi-function device.

Ground station 14 includes an operator control unit (OCU) that is employed by a pilot to communicate with and control the flight of UAV 12. Ground station 14 may include a display device for displaying and charting flight locations of UAV 12, as well as video communications from the UAV in flight. Ground station 14 may also include a control device for a pilot to control the trajectory of UAV 12 in flight. For example, ground station 14 may include a control stick that may be manipulated in a variety of directions to cause UAV 12 to change its flight path in a variety of corresponding directions. In another example, ground station 14 may include input buttons, e.g. arrow buttons corresponding to a variety of directions, e.g. up, down, left, and right that may be employed by a pilot to cause UAV 12 to change its flight path in a variety of corresponding directions. In another example, ground station 14 may include another pilot control for directing UAV 12 in flight, including, e.g. a track ball, mouse, touchpad, touch screen, or freestick. Other input mechanisms for controlling the flight path of UAV 12 are contemplated to include waypoint and route navigation depending on the FAA regulations governing the specific mission and aircraft type.

In addition to the display and pilot control features, ground station 14 may include a computing device that includes one or more processors and digital memory for storing data and executing functions associated with the ground station. A telemetry module may allow data transfer to and from ground station 14 and UAV 12, as well as ATC tower 16, e.g., according to a wired technique or one of the wireless communication techniques described above.

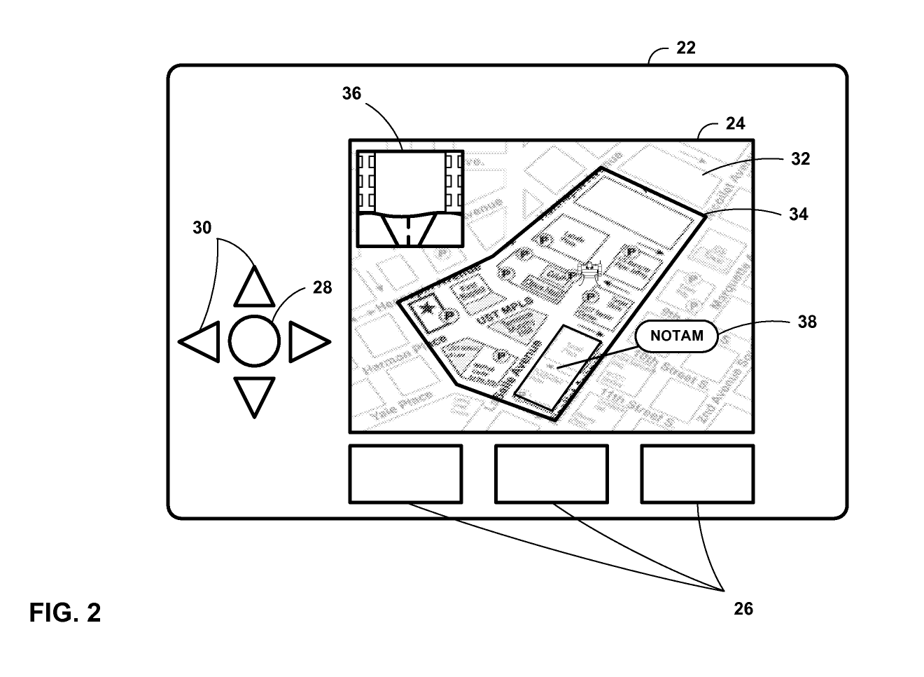

In one example, ground station 14 includes a handheld OCU including an LCD display and control stick. The SWAT UAV pilot may employ the LCD display to define the flight locations of UAV 12 and view video communications from the vehicle. During flight of UAV 12, the SWAT pilot may control the flight path of the UAV by moving the control stick of ground station 14 in a variety of directions. The SWAT pilot may employ the handheld OCU of ground station 14 to define one or more flight locations for UAV 12, automatically generate an electronic flight plan based on the flight locations for the UAV, and transmit the flight plan to an ATC system via ATC tower 16. The configuration and function of ground station 14 is described in greater detail with reference to example OCU 22 of FIG. 2.

FIG. 2 is a schematic diagram of example OCU 22, which may be employed at ground station 14 by, e.g., the SWAT UAV pilot to communicate with and control the trajectory of UAV 12 in flight. The SWAT pilot may also employ OCU 22 to automatically generate and file an electronic flight plan for UAV 12 with an ATC system via ATC tower 16 to quickly and easily secure approval for flying the UAV in a controlled airspace. OCU 22 includes display 24, input buttons 26, and control stick 28. Arrows 30 display up, down, left, and right directions in which control stick 28 may be directed by, e.g., the SWAT UAV pilot to control the flight of UAV 12.

In the example of FIG. 2, display 24 may be a touch screen display capable of displaying text and graphical images related to operating UAV 12 in flight and of receiving user input for defining and automatically generating a flight plan for the UAV in a controlled airspace. For example, display 24 may be an LCD touch screen display capable of receiving input from the SWAT UAV pilot via, e.g., one of the pilot's fingers or a stylus.

Input buttons 26 may enable a variety of functions related to OCU 22 to be executed by, e.g., the SWAT UAV pilot or another user. In one example, buttons 26 may execute specific functions, including, e.g., a powering OCU 22 on and off, controlling parameters of display 24, e.g. contrast or brightness, or navigating through a user interface. In another example, however, one or more of buttons 26 may execute different buttons depending on the context in which OCU 22 is operating at the time. For example, some of buttons 26 may include up and down arrows, which may alternatively be employed by the SWAT UAV pilot to, e.g., control the illumination level, or backlight level, of display 24 to navigate through a menu of functions executable by OCU 22, or to select and/or mark features on map 32. In some examples, buttons 26 may take the form of soft keys (e.g., with functions and contexts indicated on display 24), with functionality that may change, for example, based on current programming operation of OCU 22 or user preference. Although example OCU 22 of FIG. 2 includes three input buttons 26, other examples may include fewer or more buttons.

Control stick 28 is a pilot control device configured to enable a user of OCU 22, e.g., the SWAT UAV pilot, to control the path of UAV 12 in flight. In the example of FIG. 2, control stick 28 may be a “joy stick” type device that is configured to be moved in any direction 360 degrees around a longitudinal axis of the control stick perpendicular to the view shown in FIG. 2. For example, control stick 28 may be moved in up, down, left, and right directions generally corresponding to the directions of up, down, left and right arrows 30 on OCU 22. Control stick 28 may also, however, be moved in directions intermediate to these four directions, including, e.g., a number of directions between up and right directions, between up and left directions, between down and right, or between down and left directions. In another example, control stick 28 may be another pilot control device, including, e.g., a track ball, mouse, touchpad or a separate freestick device.

As noted above, a pilot, e.g., the SWAT UAV pilot may employ OCU 22 as part of ground station 14 to communicate with and control the trajectory of UAV 12 in flight, as well as to automatically generate and file an electronic flight plan for the UAV with an ATC system via ATC tower 16 to quickly and easily secure approval for flying the UAV in a controlled airspace. In one example, the SWAT UAV pilot may need to operate UAV 12 in an area including controlled airspace. In such an example, display 24 of OCU 22 may generate and display map 32 of the area within which the SWAT UAV pilot needs to operate UAV 12. In some examples, map 32 may be automatically retrieved from a library of maps stored on memory of OCU 22 based on a Global Positioning System (GPS) included in the OCU or manually by the pilot. In other examples, map 32 may be stored by a remote device other than OCU 22, e.g., a remote database or a computing device that is in wired or wireless communication with OCU 22.

In some examples, map 32, as well as the flight locations described in detail below, may be formatted to be compatible with the ATC system, such as sectional charts, to which the flight plan will be transmitted, e.g. via ATC tower 16. In one example, the format employed by OCU 22 for map 32 may include sectional charts, airport approach plates, and notice to air man (NOTAM) messages. A sectional chart is a type of aeronautical chart employed in the United States that is designed for navigation under Visual Flight Rules (VFR). A sectional chart may provide detailed information on topographical features, including, e.g., terrain elevations, ground features identifiable from altitude (e.g. rivers, dams, bridges, buildings, etc.), and ground features useful to pilots (e.g. airports, beacons, landmarks, etc.). Such charts may also provide information on airspace classes, ground-based navigation aids, radio frequencies, longitude and latitude, navigation waypoints, navigation routes, and more. Sectional charts are available from a variety of sources including from the FAA and online from “SkyVector” (at www.skyvector.com).

In one example, OCU 22 may be configured to present map 32 and other elements, such as flight locations, to operators in different kinds of graphical formats on display 24. OCU 22 may, for example, be configured to process standard graphical formats, including, e.g. CADRG, GeoTiff, Satellite Imagery, CAD drawings, and other standard and proprietary map and graphics formats.

OCU 22 may also generate overlay objects (including point areas and lines) to create boundaries on map 32 that comply with FAA UAV flight regulations in the airspace in which UAV 12 is expected to operate, as well as boundaries generated by the ATC system. For example, OCU 22 may generate boundaries that mark where class C and class B airspaces intersect. OCU 22 may also display overlays of dynamically approved ATC flight plan boundaries on map 24. Additional features including city and building details and photos may be overlaid on map 32 as well.

Additionally, using touch screen display 24 and/or input buttons 26, the SWAT UAV pilot may pan, zoom, or otherwise control and/or manipulate map 32 displayed on the display of OCU 22. The SWAT UAV pilot may also employ the picture-in-picture (PIP) first person window 36 to operate UAV 12, which can display video signals transmitted from a camera onboard the UAV to represent the perspective from the vehicle as it flies. However, before piloting UAV 12 in the area represented by map 32, a flight plan may be generated and filed to secure approval for flying in the controlled airspace.

The SWAT UAV pilot may employ OCU 22 to automatically generate and transmit a flight plan to an ATC system, e.g., via ATC tower 16 of system 10 of FIG. 1. In one example, the SWAT UAV pilot defines one or more flight locations for UAV 12 using OCU 22. For example, the SWAT UAV pilot may draw one or more flight locations for UAV 12 on touch-screen display 24 of OCU 22 using, e.g., one of the pilot's finger or with a stylus or other computer pointing device. In the example of FIG. 2, the flight locations of UAV 12 have been defined by drawing flight area 34 on touch-screen 24 of OCU 22, which represents the locations the UAV is expected to fly during the execution of the SWAT team mission, or at least the area in which clearance for UAV 12 flight is desirable. Flight area 34 drawn on touch-screen 24 of OCU 22 may be any number of regular or irregular shapes, including, e.g., any number of different polygon shapes or circular, elliptical, oval or other closed path curved shapes.

In another example, instead of defining the flight locations as flight area 34, the SWAT UAV pilot may draw a flight path along or about which UAV 12 is expected to fly on touch-screen display 24 of OCU 22 to define the flight locations of the UAV. For example, the SWAT UAV pilot may define a flight path on display 24 of OCU 22 that corresponds to a section of a highway along or about which UAV 12 is expected to fly. In other examples, a user of OCU 22, e.g. the SWAT UAV pilot may define the flight locations of UAV 12 in a different manner. For example, in a mission in which emergency personnel activities will be limited to a single building, a user may simply select a building or other landmark on map 32 around which and within which UAV 12 is expected to fly. OCU 22 may then automatically select a radius around the selected building or other landmark to automatically generate the flight location of UAV 12.

In some examples, OCU 22 may automatically limit the flight locations of UAV 12 defined by the SWAT UAV pilot. The FAA prescribes a limit on the distance away from the pilot-in-control (PIC) a UAV may fly. The distance limit prescribed by the FAA is referred to herein as the UAV range limit from PIC (URLFP). In one example, therefore, the SWAT UAV pilot defines one or more flight locations for UAV 12 using OCU 22. For example, the SWAT UAV pilot may draw flight area 34 on touchscreen 24 of OCU 22, which represents the locations the UAV is expected to fly in the execution of the SWAT team mission. However, some or all of the boundary flight area 34 may exceed the URLFP, which may, e.g., be stored in memory of OCU 22 or another device in communication with OCU, for flights of UAV 12. OCU 22 may automatically detect that the current location of the pilot, which may be assumed to correspond to the location of the OCU is outside of the URLFP by, e.g., detecting the location of the OCU with a GPS included in the device or another device of ground station 14, calculating distances between the location of the OCU and the boundary of flight area 34, and comparing the distances to the URLFP. OCU 22 (or a processor of another device) may automatically modify flight area 34 to snap some or the entire boundary of the area to within the URLFP.

In this manner, the SWAT UAV pilot, or other pilot of UAV 12 need not have specific knowledge or training with respect to FAA regulations on UAV range limits, as OCU 22 may be configured to automatically adjust the flight locations of the UAV to comply with the relevant rules. In one example, OCU 22 may also be configured to download current flight regulations from a remote database, e.g. via a local internet connection, in order to correctly execute the automated flight planning functions described in this application. Other special restrictions to the flight area may be automatically generated by OCU 22 as well. For example OCU 22 may automatically construct a boundary at a Class B airspace where the FAA has designated that no UAVs may fly.

After the flight locations are defined by the SWAT UAV pilot, OCU 22 may automatically generate an electronic flight plan based thereon. For example, OCU 22 receives the flight locations for UAV 12 defined by the SWAT UAV pilot or other user and automatically inputs the locations into a flight plan that may then be transmitted to an ATC system, e.g., via ATC tower 16 in example system 10 of FIG. 1. The flight locations employed by OCU 22 to automatically populate the flight plan may be defined in any of a number of different ways, including, e.g., those described above for defining a flight path or a area, e.g. flight area 34 in the example of FIG. 2.

In one example, OCU 22 converts the flight locations defined by the SWAT UAV pilot into GPS data before populating the flight plan and transmitting the plan to the ATC system via ATC tower 16. For example, as described in the above examples, the SWAT UAV pilot may define the flight locations of UAV 12 graphically using display 24 of OCU 22. However, the ATC system may require flight locations for flight plans to be defined numerically, e.g., in terms of GPS location data. As such, OCU 22 may be configured to automatically convert the flight locations defined by the SWAT UAV pilot to GPS data by, e.g., transposing the flight path or area defined on map 32 on display 24 into a number or array of GPS data points representing the flight locations in terms of their absolute positions.

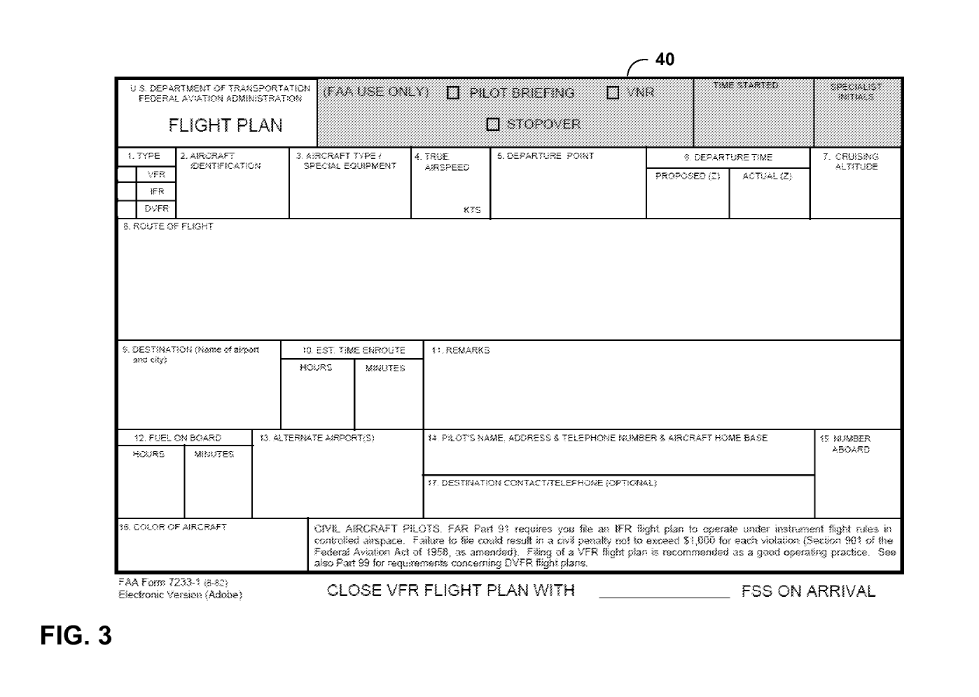

Flight plans are generally governed by FAA regulations and include the same information regardless of where the flight occurs or the type of aircraft to which the plan relates. An example flight plan 40 based on FAA Form 7233-1 is shown in FIG. 3. As illustrated in the example of FIG. 3, a flight plan may include pilot, aircraft, and flight information. For example, example flight plan 40 of FIG. 3 requires aircraft identification, type, maximum true air speed, and color, the amount of fuel and passengers on board the aircraft, as well as the name, address, and telephone number of the pilot operating the aircraft. Flight plan 40 also requires the type of flight to be executed, e.g. visual or instrument flight rules (VFR or IFR), or Defense Visual Flight Rules (DVFR), which refers to one type of flight plan that must be filed for operation within an Air Defense Identification Zone. Other information related to the flight on flight plan 40 includes the departure point and time, cruising altitude, route, and time of the flight.

Although some of the information required for flight plans depends on the particular flight being executed, e.g., the flight locations of UAV 12 defined by the pilot using OCU 22, much of the information is repeated for different flights of the same aircraft by one or more of the same pilots. As such, in one example, parts of the flight plan automatically generated by OCU 22, e.g., according to example flight plan 40 of FIG. 3 may be pre-populated and, e.g., stored in memory of the OCU or another device in communication with the OCU in the form of one or more flight plan templates. For example, memory of OCU 22 may store a flight plan that includes pilot information, vehicle information, and/or standard flight information.

Referring again to example flight plan 40 of FIG. 3, in one example, OCU 22 stores a flight plan template for UAV 12 that includes aircraft information that does not change from one flight to another of UAV 12, including, e.g., the aircraft identification, e.g. the tail number of UAV 12, aircraft type, the true airspeed of UAV 12, the cruising altitude, which may be a default altitude at which UAV 12 is ordinarily operated, the fuel on board, color of UAV 12, the number of passengers aboard, i.e., zero for UAV 12. The pre-populated flight plan template stored on OCU 22 may also including information about the pilot of UAV 12, including, e.g., the pilot's name, address and telephone number, and aircraft home base.

OCU 22 may store multiple flight plan templates that vary based on different characteristics of the plan. For example, OCU 22 may store multiple flight plan templates for multiple pilots that may employ OCU 22 to operate UAV 12. In such examples, the pilot specific flight plan templates stored on OCU 22 may vary by including different pilot information pre-populated in each plan, e.g., the pilot's name, address and telephone number, and aircraft home base. In another example, OCU 22 may store multiple flight plan templates for different UAVs that may be operated using the OCU. In such examples, the vehicle specific flight plan templates stored on OCU 22 may vary by including different vehicle information pre-populated in each plan, e.g., the tail number, true airspeed, cruising altitude, fuel on board, color, the number of passengers aboard the UAV.

Some or all of the vehicle, flight, or pilot information described above as pre-populated in flight plan templates stored on OCU 22 may also, in some examples, be input by the pilot operating UAV 12. For example, the pilot may employ OCU 22 to input their own information into the flight plan automatically generated by the OCU. In one example, the pilot may be identified by logging into OCU 22, which in turn automatically populates the flight plan with information associated with the pilot login stored in memory of the OCU. In another example, the pilot may select their name from a drop down list, or other selection mechanism, of stored pilots displayed on display 24 of OCU 22, which, in turn, automatically populates the flight plan with information associated with the pilot's name stored in memory of the OCU. In another example, OCU 22 or ground station 14 may include equipment by which the SWAT UAV pilot may be identified and their information automatically added to the flight plan using biometrics, including, e.g., identifying the pilot by a finger or thumb print.

Information about the particular UAV, e.g., UAV 12 may be input into the flight plan by the pilot using OCU 22 in a similar manner as for pilot information in some examples. For example, the pilot may select a UAV, e.g. by tail number from a drop down list, or other selection mechanism of possible UAVs on display 24 of OCU 22, which, in turn, automatically populates the flight plan with information associated with the selected UAV stored in memory of the OCU.

In some examples, OCU 22 may automatically prompt the SWAT UAV pilot to input any information that is required to complete a flight plan. For example, the foregoing examples for inputting pilot, flight, and vehicle information may be automated by OCU 22 prompting the pilot to input any of this information not automatically filled in by the OCU. In this manner, the SWAT UAV pilot may provide the information necessary to generate a flight plan without having prior knowledge of flight plan content or requirements.

In addition to the foregoing examples of flight plan information generated, stored, or input on OCU 22, other information required for the plan may be generated or input at the time the pilot operates UAV 12 in a controlled airspace. Such real-time flight plan information, in addition to the flight locations which is described below, may either be automatically generated by OCU 22 or input by the pilot and includes, e.g., information about the time and the departure location of the flight. For example, as illustrated in example flight plan 40 of FIG. 3, the flight plan automatically generated by OCU 22 may require the departure and flight time for the flight of UAV 12 and the location from which the UAV will depart.

Some or all of this time and location information may be automatically generated by OCU 22. For example, OCU 22 may employ GPS onboard UAV 12 or within the OCU to determine the location from the UAV will depart on its flight. Additionally, in one example, OCU 22 may maintain a connection to the Internet or another network, e.g. cellular or satellite, by which the device may maintain the time of day according to some standardized mechanism. For example, OCU 22 may retrieve the time of day from via the Internet from the National Institute of Standards and Technology (NIST) Internet Time Service (ITS). In another example, OCU 22 may rely on the time of day supplied by a clock executed on the OCU. The estimated flight time, or estimated time enroute as it is designated in example flight plan 40 of FIG. 3, may be a default mission flight time pre-populated in a flight plan template or the pilot may employ OCU 22 to input an estimate of the flight time.

After automatically generating the flight plan based on the flight locations of UAV 12, OCU 22 may transmit the flight plan automatically or at the behest of the pilot to the ATC system, e.g., via ATC tower 16 of FIG. 1, to seek approval to fly in the controlled airspace. Electronically transmitting the flight plan to the ATC system may eliminate the step of physically delivering or otherwise manually filing a flight plan to ATC operators common in the past, which, in turn, may act to increase the rapidity with which the SWAT team, or other emergency response personnel, may respond to an emergency. As described with reference to the example of FIG. 1, ATC tower 16 may be in wired or wireless communication with both UAV 12 and OCU 22 of ground station 14. OCU 22 may therefore transmit the flight plan to the ATC system via ATC tower 16 wirelessly or via the wired connection. The wireless communications between OCU 22 and ATC tower 16 may include any of a number of wireless communication technologies, including, e.g., cellular, wireless network, or satellite technologies. For example, wireless communications between OCU 22 and ATC tower 16 may be implemented according to one of the 802.11 specification sets, or another standard or proprietary wireless network communication protocol. In another example, OCU 22 may employ wireless communications over a terrestrial cellular network, including, e.g. a GSM (Global System for Mobile Communications), CDMA (Code Division Multiple Access), EDGE (Enhanced Data for Global Evolution) network to communicate with the ATC system via ATC tower 16.

Depending on the capabilities of the ATC system, the flight plan may be transmitted by OCU 22 in a number of different formats. For example, the flight plan may be transmitted by OCU 22 as a facsimile image that is configured to be received by a facsimile device of the ATC system, which, in turn, generates a hard copy of the flight plan for review and approval/denial by an air traffic controller. In another example, OCU 22 may transmit the flight plan as an electronic document including text and graphical information in any of a number of standard or proprietary formats, e.g., the OCU may transmit the flight plan to the ATC system in Portable Document Format (PDF). In such examples, the flight plan may include a graphical representation of the flight locations of UAV 12 for which approval is sought. For example, the flight plan transmitted by OCU 22 may include a representation of map 32 and flight area 34 illustrated on display 24 of the OCU in FIG. 2. In one example, OCU 22 may generate and transmit to the ATC a graphical image of flight area 34 overlaid on a sectional chart along with the other information associated with the flight plan. In one example, the ATC system may be capable of reconstructing of flight area 34 into a graphical representation from data transmitted by OCU 22 for overlay at the ATC to facilitate rapid ATC assessment of the request.

Regardless of the format, the ATC system may approve, deny, or modify the flight plan for UAV 12 transmitted by OCU 22. For example, an air traffic controller may receive and review the flight plan transmitted by OCU 22. In the event the flight plan and other conditions are satisfactory, the controller may transmit an approval message, e.g., via ATC tower 16 to OCU 22 indicating that the SWAT UAV pilot may begin operating UAV 12 in the controlled airspace. In some cases due to the flight plan or current conditions in the airspace, e.g., temporary additional restrictions or other flights currently being executed, the air traffic controller may deny the flight plan transmitted by OCU 22. In such cases, the controller may simply transmit a denial message back to OCU 22. In another example, however, the air traffic controller may modify the flight plan in order to approve a flight of UAV 12 in the controlled airspace. For example, the controller may transmit a conditional approval message including a modification of the flight locations for UAV 12 defined by the SWAT UAV pilot. In one example, approvals from the ATC may occur using a common electronic messaging technique, including, e.g. Simple Messaging Service (SMS) text messages or e-mail messages.

In some examples, the air traffic controller dynamically updates the flight plan for UAV 12 as the pilot flies UAV 12, and transmits the updated flight plan to OCU 22. In this way, OCU 22 may provide a communication interface with which the pilot may stay apprised of the most up-to-date flight plan approved by the ATC system.

In another example, the controller may modify the flight plan and send the modified plan back to OCU 22. For example, the ATC system may provide the air traffic controller with the capability of modifying an electronic document or other representation of the flight plan transmitted by OCU 22, e.g. by graphically modifying or redefining flight area 34 defined by the SWAT UAV pilot. The modified flight plan may then be sent back to OCU 22 (via the wired or wireless communication technique) and the SWAT UAV pilot may proceed with operating UAV 12 in the modified flight area 34.

In some examples, additional information related to the airspace of the flight of UAV 12 may be added to the flight plan automatically generated by OCU 22 and transmitted to the ATC system by OCU 22. One example of such additional information includes notice to air man (NOTAM) messages. A NOTAM is a temporary or permanent augmentation to the rules governing flights in an established controlled airspace. For example, there may be a NOTAM for a condemned or dangerous building located within a controlled airspace that further limits flights near the building. In the examples disclosed herein, NOTAMS may be added to an airspace based on an automatically generated flight plan or communicated to a UAV pilot before approving the flight plan in the airspace.

In one example, along with the flight plan automatically generated by OCU 22, the OCU may generate and transmit a NOTAM to the ATC system which indicates that the flight locations defined by the SWAT UAV pilot will be occupied by a vehicle in flight if the plan is approved. Such a NOTAM generated and transmitted by OCU 22 may be automatically added to the controlled airspace by the ATC system for future flight plans that are requested. In another example, the ATC system may transmit any relevant NOTAMs that already exist in the airspace to OCU 22 with an unconditional or conditional approval of the flight plan. For example, an air traffic controller may provide conditional approval of flight area 34 defined by the SWAT UAV pilot provided the pilot restricts flight around a particular condemned building within the flight area in accordance with an existing NOTAM in the airspace, e.g. such as NOTAM 38 in flight area 34 in FIG. 2.

At any time after an initial approval of a flight plan automatically generated by OCU 22, the SWAT UAV pilot may modify or amend and retransmit the changed plan to the ATC system for approval. For example, the SWAT UAV pilot, due to conditions on the ground and information gleaned from an initial flight of UAV 12, may wish to expand flight area 34 or otherwise change the flight locations for the UAV. As such, the pilot may modify flight area 34, e.g., by drawing a different area or stretching the previously defined area on display 24 of OCU 22. OCU 22 may then automatically generate an updated flight plan based on the new flight locations for UAV 12 defined by the SWAT UAV pilot and transmit the updated flight plan to the ATC system for approval.

The above examples of FIGS. 1 and 2 have been described with reference to example OCU 22 of ground station 14. However, in other examples according to this disclosure, a UAV pilot at a ground station may employ different types of OCUs. For example, a UAV pilot may employ an OCU that includes glasses or goggles worn by the pilot and that display representations of the flight locations of the UAV and the in-flight video feed from the UAV video camera by which the pilot flies the vehicle. Such an OCU may also include a standalone control stick, e.g., a joy stick that the pilot may use to define the flight locations of the UAV on the display of the glasses/goggles and control the trajectory of the vehicle in flight.

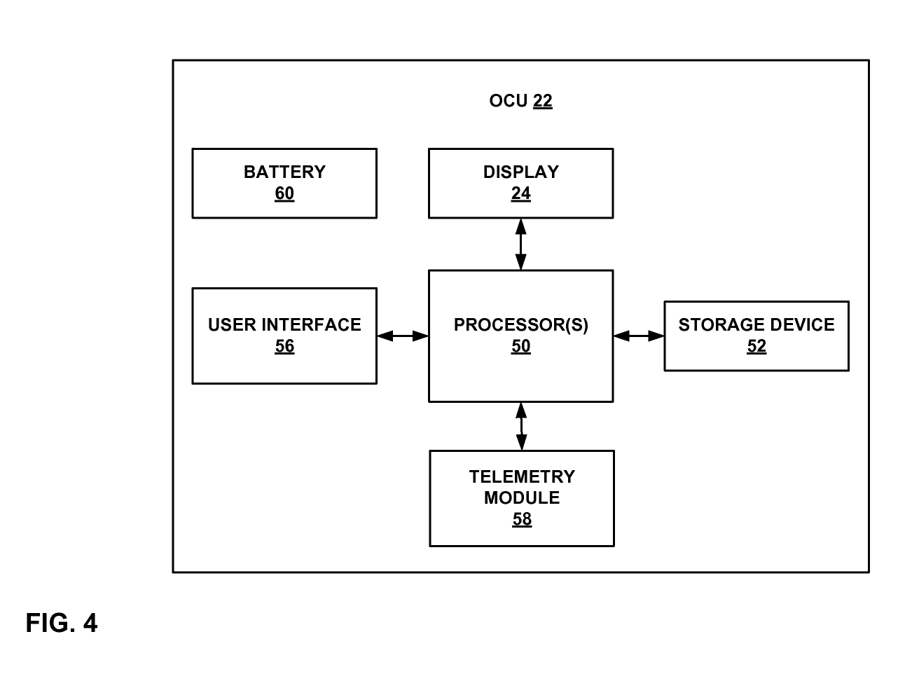

FIG. 4 is a block diagram illustrating components and electronics of example OCU 22 of FIG. 2, which include processor 50, storage device 52, display 24, user interface 56, telemetry module 58, and battery 60. Processor 50, generally speaking, is communicatively connected to and controls operation of storage device 52, display 24, user interface 56, and telemetry module 58, all of which are powered by battery 60, which may be, for example, rechargeable in some examples. Processor 50 may include any one or more of a microprocessor, a controller, a digital signal processor (DSP), an application specific integrated circuit (ASIC), a field-programmable gate array (FPGA), or equivalent discrete or integrated logic circuitry. The functions attributed to processor 50 in this disclosure may be embodied as software, firmware, hardware and combinations thereof Although example OCU 22 of FIG. 4 is illustrated as including one processor 50, other example devices according to this disclosure may include multiple processors that are configured to execute one or more functions attributed to processor 50 of OCU 22 individually or in different cooperative combinations.

Storage device 52 stores instructions for applications and functions that may be executed by processor 50 and data used in such applications or collected and stored for use by OCU 22. For example, storage device 52 may store flight plan templates employed by processor 50 to automatically generate flight plans based on the flight locations of UAV 12 defined by the SWAT UAV pilot. As another example, storage device 52 may store pilot information, UAV information, and different maps for use by a pilot or another user to define a flight location. Storage device 52 may be a computer-readable, machine-readable, or processor-readable storage medium that comprises instructions that cause one or more processors, e.g., processor 50, to perform various functions. Storage device 52 may include any volatile, non-volatile, magnetic, optical, or electrical media, such as a random access memory (RAM), read-only memory (ROM), non-volatile RAM (NVRAM), electrically-erasable programmable ROM (EEPROM), flash memory, or any other digital media. Storage device 52 may include instructions that cause processor 50 to perform various functions attributed to the processor in the disclosed examples.

Storage device 52 includes memory that stores software that may be executed by processor 50 to perform various functions for a user of OCU 22, including, e.g., generating flight plans based on one or more flight locations for UAV 12 defined by a pilot, e.g., the SWAT UAV pilot and operating the UAV in flight. The software included in OCU 22 may include telemetry, e.g. for communications with an ATC system via ATC tower 16, and other hardware drivers for the device, operating system software, and applications software. In some examples, the operating system software of OCU 22 may be, e.g., Linux software or another UNIX based system software. In another example, OCU 22 may include proprietary operating system software not based on an open source platform like UNIX.

Operation of OCU 22 may require, for various reasons, receiving data from one or more sources including, e.g., an ATC system via ATC tower 16, as well as transmitting data from the device, e.g., flight plans or flight control signals to one or more external sources, which may include the ATC system and UAV 12, respectively. Data communications to and from OCU 22 may therefore generally be handled by telemetry module 58. Telemetry module 58 is configured to transmit data/requests to and receive data/responses from one or more external sources via a wired or wireless network. Telemetry module 58 may support various wired and wireless communication techniques and protocols, as described above with reference to communications between OCU 22 and ATC tower 16, and includes appropriate hardware and software to provide such communications. For example, telemetry module 58 may include an antenna, modulators, demodulators, amplifiers, compression, and other circuitry to effectuate communication between OCU 22 and ATC tower 16, as well as UAV 12, and local and remote terminals 18 and 20, respectively.

OCU 22 includes display 24, which may be, e.g., a LCD, LED display, e-ink, or other display. Display 24 presents the content of OCU 22 to a user, e.g., to the SWAT UAV pilot. For example, display 24 may present the applications executed on OCU 22, such as a web browser, as well as information about the flight plan for and operation of UAV 12, including, e.g., PIP first person window 36 illustrated in FIG. 2. In some examples, display 24 may provide some or all of the functionality of user interface 56. For example, display 24 may be a touch screen that allows the user to interact with OCU 22. In one example, the SWAT UAV pilot defines flight locations for UAV 12 by drawing or otherwise inputting the locations on display 24. For example, the pilot defines flight locations for UAV 12 by drawing flight area 34 within which the vehicle is expected to fly in the execution of a mission. In any event, user interface 56 allows a user of OCU 22 to interact with the device via one or more input mechanisms, including, e.g., input buttons 26, control stick 28, an embedded keypad, a keyboard, a mouse, a roller ball, scroll wheel, touch pad, touch screen, or other devices or mechanisms that allow the user to interact with the device.

In some examples, user interface 56 may include a microphone to allow a user to provide voice commands. Users may interact with user interface 56 and/or display 24 to execute one or more of the applications stored on storage device 52. Some applications may be executed automatically by OCU 22, such as when the device is turned on or booted up or when the device automatically generates a flight plan for UAV 12 based on the flight locations for the vehicle defined by the pilot. Processor 50 executes the one or more applications selected by a user, or automatically executed by OCU 22.

Battery 60 provides power for all if the various components of OCU 22, and may be rechargeable. Examples of battery 60 include a lithium polymer battery, a lithium ion battery, nickel cadmium battery, and a nickel metal hydride battery.

Processor 50 is configured to operate in conjunction with display 24, storage device 52, user interface 56, and telemetry module 58 to carry out the functions attributed to OCU 22 in this disclosure. For example, the SWAT UAV pilot may draw one or more flight locations for UAV 12 on touchscreen display 24 of OCU 22 using, e.g., one of the pilot's finger or with a stylus. Processor 50 may then automatically generate a flight plan based on the flight locations for UAV 12.

In one example, the pilot may input additional information, including, e.g., flight, vehicle, and pilot information via display 24 and/or user interface 56 of OCU 22. Processor 50 may receive this data from the pilot and add the data to a flight plan template stored on storage device 52 or a new flight plan generated by processor 50. Processor 50 may also interact with one or more software or hardware components to automatically generate flight plan information in addition to the flight locations of UAV 12. For example, processor 50 may access and execute a clock application stored on storage device 52 or a remote device to determine the departure time for the flight of UAV 12. Processor 50 may also access GPS software and/or hardware included in OCU 22 or a remote device to determine the departure location for the flight of UAV 12.

In one example, processor 50 may execute an algorithm, e.g., stored on storage device 52, that converts the flight locations for UAV 12 defined graphically on display 24 into GPS data. Processor 50 may then add the GPS data based flight locations to the flight plan for UAV 12. For example, processor 50 may execute an algorithm stored on storage device 52 that transposes the flight path or area defined on display 24 by the SWAT UAV pilot into an array of GPS data points representing the flight locations of UAV 12 in terms of absolute positions.

After generating the flight plan, processor 50 may interact with and/or control telemetry module 58 to transmit the plan to an ATC system, e.g. via ATC tower 16, via a wired or wireless communication line. Processor 50 and telemetry module 58 may also function separately or in conjunction with one another to receive flight plan approvals, denials, and modifications from the ATC system via ATC tower 16.

Processor 50 may also execute additional functions attributed to OCU 22 in the examples described above with reference to FIG. 2. For example, processor 50 may generate, receive, and interpret NOTAMs for the controlled airspace within which UAV 12 is operating and may, in some examples, operate in conjunction with telemetry module 58 to transmit a NOTAM related to a flight plan automatically generated by the processor to the ATC system. Additionally, processor 50 may handle any modifications or amendments made to a flight plan previously approved, as well as communications with and processing of approvals for the changes from the ATC system.

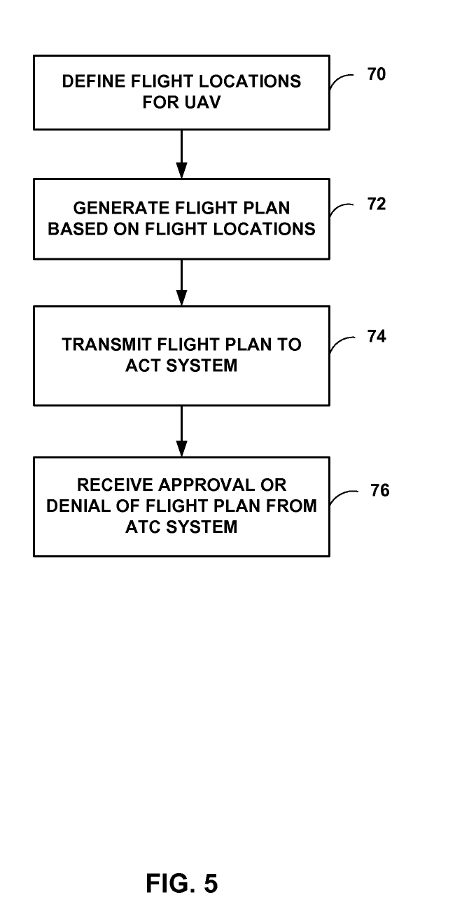

FIG. 5 is a flow chart illustrating an example method of automatically generating and filing a flight plan for a UAV in a controlled airspace. The example method of FIG. 5 includes defining one or more flight locations for a UAV (70), automatically generating an electronic flight plan based on the one or more flight locations for the UAV (72), and transmitting the flight plan to an ATC system (74). In some examples, the method of FIG. 5 also includes receiving an approval or denial of the flight plan from the ATC system (76).

In examples described herein, the method of FIG. 5 for generating and filing UAV flight plans is described as being executed by example OCU 22. However, in other examples, the functions associated with the method of FIG. 5 may be executed by other operator control units associated with a ground station for a UAV, which may be configured differently and employed on different UAVs, or associated with other devices. For example, an alternative operator control unit may include goggles including an electronic display worn by a UAV pilot and a standalone control stick employed by the pilot to define flight locations for the UAV and control the vehicle in flight.

The method of FIG. 5 includes defining one or more flight locations for a UAV (70). For example, the SWAT UAV pilot may draw one or more flight locations for UAV 12 on touch-screen display 24 of OCU 22 using, e.g., one of the pilot's finger, with a stylus, or another input mechanism (e.g., a peripheral pointing device). In the example of FIG. 2, the flight locations of UAV 12 have been defined by drawing flight area 34 on touch-screen 24 of OCU 22, which represents the locations the UAV is expected to fly in the execution of the SWAT team mission. In another example, however, instead of defining the flight locations as flight area 34, the SWAT UAV pilot may draw a flight path along or about which UAV 12 is expected to fly on touch-screen display 24 of OCU 22 to define the flight locations of the UAV. In other examples, a user of OCU 22, e.g. the SWAT UAV pilot may define the flight locations of UAV 12 in a different manner. For example, in a mission in which emergency personnel activities will be limited to a single building or other landmark, a user may simply select a building or landmark on map 32 around which and within which UAV 12 is expected to fly.

In some examples, OCU 22, e.g., processor 50, may automatically limit the flight locations of UAV 12 defined by the SWAT UAV pilot, e.g., based on a UAV range limit to PIC (URLFP) prescribed by the FAA. In one example, the SWAT UAV pilot may draw flight area 34 on touch-screen 24 of OCU 22, which represents the locations the UAV is expected to fly in the execution of the SWAT team mission. However, some or all of the boundary flight area 34 may exceed the URLFP, which may, e.g., be stored in storage device 52 for flights of UAV 12. In one example, processor 50 automatically detects that the current location of the pilot, which may be assumed to correspond to the location of OCU 22, is outside of the URLFP by, e.g., detecting the location of the OCU with a GPS included in the device or another device of ground station 14, calculating distances between the location of the OCU and the boundary of flight area 34, and comparing the distances to the URLFP. As such, processor 50 of OCU 22 may automatically modify flight area 34 to snap some or the entire boundary of the area to within the URLFP, or otherwise automatically limit flight area 34 to URLFP.

In addition to defining the flight locations for UAV 12 (70), the method of FIG. 5 includes automatically generating a flight plan based thereon (72). For example, processor 50 of OCU 22 may receive the flight locations for UAV 12 defined by the SWAT UAV pilot and automatically input the locations into a flight plan that may then be transmitted to an ATC system, e.g., via ATC tower 16 in example system 10 of FIG. 1. The flight locations employed by OCU 22 to populate the flight plan may be defined in any of a number of different ways, including, e.g., those described above for defining a flight path or a area, e.g., flight area 34 in the example of FIG. 2. Additionally, in some examples, processor 50 may execute an algorithm, e.g., stored on storage device 52 (FIG. 4) that converts the flight locations for UAV 12 defined graphically on display 24 into GPS data. Processor 50 may then add the GPS data based flight locations to the flight plan for UAV 12.

Although some of the information required for a flight plan depends on the particular flight being executed, e.g., the flight locations of UAV 12 defined by the pilot using OCU 22, some of the information may be repeated for different flights of the same aircraft by one or more of the same pilots. As such, in one example, parts of the flight plan automatically generated by processor 50 of OCU 22, e.g., according to example flight plan 40 of FIG. 3 may be pre-populated and, e.g., stored in storage device 52 in the form of one or more flight plan templates. For example, storage device 52 of OCU 22 may store a flight plan that includes pilot information, vehicle information, and/or standard flight information. OCU 22, and, in particular, storage device 52 may store multiple flight plan templates that vary based on different characteristics of the plan, including, e.g. different pilots that operate a UAV and different UAVs that are operated by one or more pilots. Some or all of the vehicle, flight, or pilot information described as pre-populated in flight plan templates on storage device 52 of OCU 22 may also, in some examples, be input by the pilot operating UAV 12.

In addition to the foregoing examples of flight plan information generated by processor 50, stored on storage device 52, and/or input by display 24 and/or user interface 56, other information required for the plan may be generated or input at the time the pilot operates UAV 12 in a controlled airspace. Such real-time flight plan information, in addition to the flight locations which is described below, may either be automatically generated by, e.g., processor 50 of OCU 22 or input by the pilot and includes, e.g., information about the time and the departure location of the flight. By eliminating or at least reducing the requirement for the user to directly fill out a FAA flight plan form in some examples, OCU 22 may provide a more user friendly interface with which the user may generate a flight plan, and may ease the level of skill or knowledge required to generate a flight plan and file the flight plan with an ATC system.

In addition to automatically generating the flight plan based on the flight locations of UAV 12 (72), in the method of FIG. 5, processor 50, e.g., with the aid of telemetry module 58, of OCU 22 transmits the flight plan automatically or at the behest of the pilot to the ATC system (74), e.g., via ATC tower 16 of FIG. 1, to seek approval to fly in the controlled airspace. In some examples, processor 50 may control telemetry module 58 of OCU 22 to wirelessly transmit the flight plan to the ATC system via ATC tower 16 in accordance with any of a number of wireless communication technologies, including, e.g., cellular, wireless network, or satellite technologies. In other examples, processor 50 may be in communication with the ATC system via a wired link. The flight plan may be transmitted by processor 50 and/or telemetry module 58 of OCU 22 in a number of different formats, depending on the capabilities and limitations of the ATC system.

In some examples, after transmitting the flight plan to the ATC system (94), OCU 22 may receive a conditional or unconditional approval or a denial of the flight plan from the ATC system (76). For example, processor 50 may interact with and/or control telemetry module 58 to wirelessly transmit the plan to an ATC system, e.g., via ATC tower 16. Processor 50 and telemetry module 58 may then also function separately or in conjunction with one another to receive flight plan approvals, denials, and modifications from the ATC system via ATC tower 16.

In some examples, the method of FIG. 5 may include additional functions executed by OCU 22, or another device or system. In one example, the method of FIG. 5 further includes the generation and transmission of one or more NOTAMs between OCU 22 and the ATC system. For example, processor 50 may generate, receive, and interpret NOTAMs for the controlled airspace within which UAV 12 is operating and may, in some examples, operate in conjunction with telemetry module 58 to transmit a NOTAM related to a flight plan automatically generated by the processor to the ATC system. In another example, the example method of FIG. 5 may include modifying a flight plan based on, e.g., additional or different flight locations for UAV 12 and transmitting the flight plan to the ATC system for approval. For example, processor 50, alone or in conjunction with telemetry module 58 may handle any modifications or amendments made to a flight plan previously approved, as well as communications with and processing of approvals for the changes from the ATC system.

Functions executed by electronics associated with OCU 22 may be implemented, at least in part, by hardware, software, firmware or any combination thereof. For example, various aspects of the techniques may be implemented within one or more processors, including one or more microprocessors, DSPs, ASICs, FPGAs, or any other equivalent integrated or discrete logic circuitry, as well as any combinations of such components, embodied in electronics included in OCU 22. The term “processor” or “processing circuitry” may generally refer to any of the foregoing logic circuitry, alone or in combination with other logic circuitry, or any other equivalent circuitry.

Such hardware, software, firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

When implemented in software, functionality ascribed to OCU 22 and other systems described above, devices and techniques may be embodied as instructions on a computer-readable medium such as random access memory (RAM), read-only memory (ROM), non-volatile random access memory (NVRAM), electrically erasable programmable read-only memory (EEPROM), FLASH memory, magnetic data storage media, optical data storage media, or the like. The instructions may be executed to support one or more aspects of the functionality described in this disclosure. The computer-readable medium may be nontransitory.

Any of the described units, modules or components may be implemented together or separately as discrete but interoperable logic devices. Depiction of different features as modules or units is intended to highlight different functions and does not necessarily imply that such modules or units must be realized by separate hardware or software components. Rather, functionality associated with one or more modules or units may be performed by separate hardware or software components, or integrated within common or separate hardware or software components.

Various examples have been described. These and other examples are within the scope of the following claims.

1. A method of automatically filing a flight plan, the method comprising:
defining, using a computing device, one or more flight locations for an unmanned aerial vehicle (UAV);
automatically generating, using the computing device, an electronic flight plan based on the one or more flight locations for the UAV; and
transmitting the flight plan to an air traffic control (ATC) system.

2. The method of claim 1, wherein defining, using the computing device, one or more flight locations for a UAV comprises drawing the one or more flight locations on a map displayed by the computing device.

3. The method of claim 2, wherein defining, using the computing device, one or more flight locations for a UAV comprises drawing at least one of a flight area or a flight path on a map displayed by the computing device.

4. The method of claim 1, wherein the one or more flight locations for the UAV comprises at least one of a flight area or a flight path for the UAV.

5. The method of claim 1 further comprising inputting, into the computing device, at least one of pilot information, vehicle information, or flight information.

6. The method of claim 5, wherein automatically generating an electronic flight plan comprises automatically generating an electronic flight plan comprising the at least one of pilot information, vehicle information, or flight information and the one or more flight locations for the UAV.

7. The method of claim 1, wherein automatically generating an electronic flight plan comprises adding the one or more flight locations to an electronic flight plan template comprising at least one of pilot information, vehicle information, or flight information.

8. The method of claim 1 further comprising converting, using the computing device, the one or more flight locations to Global Positioning System (GPS) data and adding the GPS data to the flight plan.

9. The method of claim 1 further comprising generating a notice to air man (NOTAM) comprising the one or more flight locations for the UAV.

10. The method of claim 9 further comprising transmitting the NOTAM to the ATC system.

11. The method of claim 9 further comprising adding the NOTAM to the flight plan.

12. The method of claim 1 further comprising automatically modifying the flight locations for the UAV based on a range limit on flight of the UAV from a fixed location.

13. The method of claim 1 further comprising automatically modifying the flight locations for the UAV based on a boundary of a controlled airspace.

14. The method of claim 1 further comprising receiving at least one of an unconditional approval, a conditional approval, or a denial of the flight plan from the ATC system.

15. The method of claim 14, wherein a conditional approval of the flight plan from the ATC system comprises at least one modification of the flight locations for the UAV.

16. An operator control unit (OCU) for an unmanned aerial vehicle (UAV), the OCU comprising:
a processor configured to receive input defining one or more flight locations for the UAV, automatically generate an electronic flight plan based on the one or more flight locations for the UAV, and transmit the flight plan to an air traffic control (ATC) system; and
a display configured to represent the one or more flight locations for the UAV.

17. The OCU of claim 16, wherein the display is configured to represent the one or more flight locations for the UAV as at least one of a flight area or a flight path.

18. The OCU of claim 17, wherein the display is configured to represent the one or more flight locations for the UAV as at least one of a flight area or a flight path overlaid on a map of an airspace.

19. The OCU of claim 16, wherein the display is configured to represent one or more notice to air man (NOTAM) messages for an airspace within which the one or more flight locations of the UAV are located.

20. A computer-readable storage medium includes instructions for causing at least one programmable processor to:
define one or more flight locations for an unmanned aerial vehicle (UAV);
automatically generate an electronic flight plan based on the one or more flight locations for the UAV; and
transmit the flight plan to an air traffic control (ATC) system.
